(19) United States
(12) Patent Application Publication
(10) Pub. No.: US 2003/0216932 A1
(43) Pub. Date: Nov. 20, 2003

(54) Automated trading of financial interests

(76) Inventor: Kevin Foley, New York, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/290,017

(22) Filed: Nov. 7, 2002

Related U.S. Application Data
(60) Provisional application No. 60/348,161, filed on Nov. 7, 2001.
(60) Provisional application No. 60/400,617, filed on Aug. 2, 2002.

(51) Int. Cl. G06F 17/60

(52) U.S. Cl. 705/1; 705/35; 705/36

(57) ABSTRACT

The invention provides systems, methods, and computer programming for transactions of financial interests without disclosing the existence of the proposals or all or certain terms of thereof at one or more stages of the proposal or the transaction. The invention is suited to, among other things, buying and or selling of large blocks of financial interests such as stocks, bonds, futures contracts, commodities, derivatives, options, and the like, without revealing in the market place that large quantities of the interests are being offered or bid upon, and without revealing the identity of the offering or bidding party or the terms upon which trades are proposed. In matching proposed transactions, systems according to the invention may give precedence to quantity over other terms, such as price or the order in which proposals are received by the system.

### RELATED APPLICATIONS

This application claims the benefit of U.S. Provisional Patent Applications Serial No. 60/348,161, entitled Blind Trading System for Financial Interests and filed Nov. 7, 2001; and Serial No. 60/400,617, entitled Blind Trading System for Financial Interests and filed Aug. 8, 2002.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

This application contains material relating to the trading of financial interests. The trading of some financial interests is regulated, as for example by the United States Government, the various State governments, and other governmental agencies within the United States and elsewhere. The disclosure herein is made solely in terms of logical and financial possibility and advantage, without regard to possible statutory, regulatory, or other legal considerations. Nothing herein is intended as a statement or representation of any kind that any system, method or process proposed or discussed herein does or does not comply with any legal requirement whatsoever, in any jurisdiction; nor should it be taken or construed as doing so.

### BACKGROUND OF THE INVENTION

The invention relates to methods and systems for conducting transactions in financial interests. In particular, the invention relates to methods and systems for conducting transactions in financial interests without disclosing the existence of proposals for the transactions or all or certain terms of such proposals. For example, the invention relates to blind trading of financial interests.

Revealing information relating to a proposed transaction of financial interests may have an impact on the market to which the particular transaction relates, whether or not the identity of any of the parties to the proposed transaction is revealed. For example, information that a party is interested in purchasing or selling a large quantity of stock in a particular company can have an impact on the market for that stock, e.g., affecting the price of the stock. Revealing the identify of the party or parties expressing interest in purchasing or selling the interest may further impact the market.

### SUMMARY OF THE INVENTION

The invention provides for transactions of financial interests involving proposals therefore without disclosing the existence of the proposals or all or certain terms of such proposals at one or more stages of the proposal or the transaction. In accordance with the invention, a system is provided which can effect transactions in financial interests accepts and processes proposals for transactions in the financial interests without disclosing the proposals or all or certain terms thereof. Thus, system users provide proposals to such a system not knowing whether there is a proposal on the other side of a possible transaction or meeting all or certain terms of such proposals. The system processes the proposals and can match proposals that are capable of forming a transaction in a particular financial interest.

A level of access to information related to proposals is provided in accordance with the invention. For example, the existence of a proposal or any information related to the proposal may not be accessed by any user (except the user who provided the proposal) of a system implementing the invention, or all or selected users may have varying degrees of access. (A user may be an individual or a firm or related group of users, etc.)

The invention provides for automatically effecting a transaction when proposals on opposite sides of a proposed transaction exist within the system. However, the invention also contemplates that a certain activity or activities be carried out after a possible transaction is identified and before a particular proposed transaction is effected. Also, the invention provides for maintaining the identity of parties to proposed transactions in anonymity, at least up to the point at which a possible transaction is identified between proposals within the system. However, the invention also contemplates that the identity of any party having a pending proposal be revealed initially or at any stage in a proposed or effected transaction, for example to system administrators, or automated administrative functions, prior to matching of proposals and/or execution of transactions.

In a preferred embodiment, proposals for the purchase and sale of financial interests are entered over a network into a system that does not disclose the existence of proposals. Matching proposals, and/or proposals that can form the basis of a trade, are automatically identified, as for example by identifying compatible terms in potential counterproposals. A trade of matching proposals can automatically be executed, or a negotiation process can be initiated. Where proposals are identified that can form the basis of a trade, a negotiation process can be initiated, or a trade automatically executed based on parameters to which the parties have previously agreed.

The invention is suited to, among other things, buying and or selling of large blocks of financial interests such as stocks, bonds, futures contracts, commodities, derivatives, options, and the like, without revealing in the market place that large quantities of the interests are being offered or bid upon, and without revealing the identity of the offering or bidding party or the terms upon which trades are proposed.

The term “blind” is used herein to refer to trading or transacting in financial interests without revealing or disclosing the existence of proposals and/or all or certain information relating to such proposals.

The invention provides systems, methods, and computer programming for matching of orders in financial interests over a network, comprising at least one computer programmed to accept orders including price and quantity terms in one or more financial interests provided to the at least one computer by potential trading parties over the computer network for possible matching; to provide a level of access to information relating at least to the price and quantity terms of selected orders accepted by the at least one computer for possible matching that is more restrictive than a level of access to information related to orders accepted by the system other than the selected orders; and to match accepted orders while maintaining the level of access at least for selected orders that are unmatched. The system can provide a level of access to information relating at least to the price and quantity terms of a selected order or orders of a party that precludes access to such information at least by other parties. The system can also match accepted selected orders with a priority for quantity where there is not a match of both the price and quantity terms of a pair of such orders.

The invention further provides systems, methods, and computer programming for matching of orders in financial interests over a network, comprising at least one computer programmed to receive terms for proposed transactions in financial interests; to review received terms to identify proposed transactions having compatible terms; and when at least two compatible counterproposals to a single proposed transaction have been identified, to match the proposed transaction with the counterproposal which would result in trading of the greatest quantity of financial interests. The terms comprise, among other things, quantities of financial interests to be traded, and the proposals may be required to meet at least one of a minimum size restriction and a minimum aggregate value. At least some of the terms may be withheld from, or not disclosed to, trading parties other than those from whom the terms are received by the system. Compatible terms, for example for purposes of identifying compatible proposals, can include compatible price terms and/or minimum fill quantities. Optionally a match may be established subject to approval by one or both parties to the transaction, or the transaction may be executed automatically once the match has been established.

In some embodiments of the invention preference is given to quantity over price and/or the order in which proposals are received by the system in matching compatible counterproposals.

The posting of transaction proposals (that is, the receipt and acceptance by the system of transaction proposals for consideration in matching proposals), the identification of transaction proposals as compatible counterparts to other proposals, and/or the matching of proposed transactions may be qualified, or conditioned, as for example on minimum or maximum prices, time limits, or minimum order and/or minimum fill sizes. Price terms may be stated in absolute terms (for example, a fixed minimum or maximum price), or relative in relative terms, as for example to national best bid (NBB) and/or national best offer (NBO), or maximum spreads between bid and offer prices. Conditions or qualifications may be set by trading parties proposing transactions, by the system receiving the proposals and identifying compatible counterproposals and matching proposals, or both.

Identification and matching of compatible counterproposals can be performed in real time or on a periodic basis, e.g. hourly or at the end of and the system's or any other trading day

In one embodiment, a blind trading system according to the invention is incorporated as a part, or separate function, of a trading system which also supports open trading, such as those systems listed above in which proposals are disclosed to other traders, either anonymously or in conjunction with the name of the posting party. In such systems transactions proposed blindly may be matched with publicly-disclosed proposals.

Proposals may be accepted and processed by the system for either buy or sell orders, and may be binding, so that once a party has submitted a proposal that party is bound to trade if the proposal is matched by the system, or otherwise accepted by another party.

In some circumstances it is advantageous to provide blind trading capabilities for proposed transactions involving relatively large quantities of interests, or to otherwise encourage trading in large quantities of interests. For example, it can be advantageous to provide such capabilities where proposals are of such magnitude that disclosure might affect the market for the interests. In such circumstances trading systems and methods according to the invention may be configured to operate blindly when or only when trades in significantly large blocks of financial interests are proposed, or to give precedence to larger orders where compatible trades or more than one size are possible.

Categorizations of what constitutes a significantly large block of a given type of financial interest are generally made according to market custom or practice, and may vary widely in magnitude. Definitions may be made in any suitable terms, such as for example quantity or price. For example, in the equity securities trading industry, trades are widely considered to be large or significant only when they involve blocks of at least 25,000 shares of stock or approximately $1,000,000 aggregate value (which value may be adjusted for inflation and the like). At least one system according to the invention, proposed for implementation by Bloomberg L. P., requires proposals to be of such size or larger in order to be traded blindly. As an alternative, existing tier sizes established by various exchanges or trading systems, or by law or regulation, or by any other suitable source, may be used or adapted. For example, the NASD (the National Association of Securities Dealers) has classified trades in three tiers, using blocks of 1,000 shares (tier I), 500 (tier II), and 200 (tier III) shares. A proposed Bloomberg L. P. system has included the option of identifying securities for trading using the NASD tier structure, then using an internal tier structure of 25,000 shares, 10,000 shares, and 5,000 shares for blind matching and trading. Such classifications may be used in any combination for acceptance and/or minimum fill. For example, a minimum trade size of 5,000, 10,000, or 25,000 shares can be used, with minimum fill components of those or any other size. In over-the-counter (“OTC”) markets, larger minimum total trade and minimum fill requirements may be appropriate, as decentralization of the market means, for example, that larger blocks of stocks may be moved without attracting notice.

Proposals for trades larger than the required minimum may be filled on an all-or-nothing (AON) basis or filled in steps by “minimum fill” increments or components, which optionally are set to the minimum trade size. Optionally either the system or the proposing party may specify which basis is to be used.

Methods and systems according to the invention may require that a party entering a proposal specify a price, or price scheme, as part of the terms for the proposal. One preferred method requires that a definite minimum and/or maximum price, or at least a starting price in cases where some type of variable-pricing scheme is to be used, be stated for a proposed transaction; and that for an offering the price be lower than the National Best Offer (NBO), and that the price for a proposed bid be higher than the National Best Bid (NBB), at the time the order is entered.

Such price schemes are particularly useful in conjunction with equity security interests and/or other financial interests for which governmental regulations sometimes impose pricing requirements relative to the market. In general, any schemes which enable users and/or operators of the system to demonstrate to the satisfaction of regulatory authorities, such as for example the National Association of Securities Dealers (NASD) that the system gives precedence to volume trades, and that in order to trade large volumes parties using the system are willing to accept something other than the best market price in their proposals, can be used to satisfy such requirements.

Prices associated with proposals according to the invention may be stated in fixed or absolute terms (e.g., a definite dollar amount), or relative to something else. For example, prices may be pegged, positively or negatively, to some other index, such as a specified security, interest rate, or composite index.

Consideration or review of proposals for compatible counterproposals of proposals may be conditioned upon the meeting, by one or more specified indices, of one or more specified conditions. For example, prices may be pegged at absolute levels, with the order being available for reviewing and matching only so long as an associated index meets a specified condition. For example, a party may enter a standing buy order for a trade at a given price level, below NBB, in such a system. So long as NBB remains higher than the proposed price, the trade will not be posted for possible matching. When and if NBB falls below the proposed price, the trade is posted for possible matches. If NBB rises again above the proposed price, any untraded portions of the proposal will be withdrawn from consideration for matching with other orders. Or, if at the time the order is entered the price is higher than the NBB, trading will be possible until NBB rises past the stated price, at which point the proposal will be canceled or suspended.

Once the system has received terms for a proposed transaction, those terms are posted to a database of pending proposals. Pending proposals are thereafter checked against each other, and, in preferred systems, when matching pairs of bids and offers are identified, a trade is automatically executed and the parties so informed. Preferably review of pending proposals for matches is performed on a continual or periodic basis.

Proposed bids and offers may be matched according to any suitable criteria. One scheme for matching proposals is to give precedence to order size over other terms such as price, or over the time order in which similar proposals are entered, so long as any minimum or maximum price requirements are met or the proposals are otherwise qualified by compliance with other conditions or requirements for their terms. Among other advantages, such schemes encourage maximum volume movement, which can be of particular value to traders in some circumstances. Methods and systems which give precedence to quantity over price may be advantageously used even where proposals are not posted and/or trades not executed blindly. Such precedence schemes may be used, for example, in conjunction with either anonymous or open trading systems.

Precedence can be given to quantity rather than other terms, such as price, in many ways. For example, if a proposed transaction is identified as compatible with more than one counterproposal, a match can be made between the two proposals that will result in the trading of the largest quantity of financial interests, regardless of price. Or, as another example, if two proposals are matched on the basis of, for example, minimum fill, and a price difference exists between the proposal, the price at which the trade will be executed may be set in favor of the party proposing the larger trade.

Proposals are identified as compatible when they satisfy each other's terms. For example, a proposal may be qualified or conditioned on one or more of maximum/minimum buy or sell price, order size, or closing date/time limits; any proposal for a transaction in the same or an acceptable financial interest meeting those requirements could be identified as a compatible counterproposal.

Systems and methods according to the invention are adaptable for compliance with regulatory or other legal developments. For example, pegging of proposed prices can be restricted to positive pegging, where negative pegging is prohibited. As another example, some markets may restrict trading during market hours to transactions involving prices only better than the NBBO. Methods and systems according to the invention are adaptable for compliance with either restriction. In general, it is advisable that regulatory and other legal restrictions be reviewed before embodiments of the invention are implemented for trading, in order to ensure compliance.

Methods for blind trading of financial interests according to the invention may be performed with the aid of automatic trading systems implemented on data processing systems such as computers and networks of computers, through the use of suitable computer programming. In systems implementing the invention, user stations are coupled to at least one server via a private or public network system, to support trading methods according to the invention. Terms for proposed transactions are entered at user stations and transmitted to a trading system server for processing over the network. The network is not limited to local area networks (LANs), or wide area networks (WANs), and may include the Internet or other public or private electronic communications networks (ECNs).

Programming for implementing the methods of the invention on computer systems may be written in any suitable high- or low-level language, such as for example C++, Cobol, Fortran, or assembly code.

### BRIEF DESCRIPTION OF THE FIGURES

The invention is illustrated in the figures of the accompanying drawings which are meant to be exemplary and not limiting, in which like references are intended to refer to like or corresponding parts, and in which:

FIG. 1 is a schematic block diagram of a system suitable for trading of financial interests according to the invention.

FIG. 2 is a schematic flow diagram of a method for trading of financial interests according to the invention.

FIG. 3 is a schematic diagram of a computer interface screen useful for entry of terms for proposed transactions by parties desiring to trade financial interests using a system according to the invention.

### DETAILED DESCRIPTION OF THE PREFERRED EMBODIMENTS

Preferred embodiments of methods, systems, and apparatus according to the invention are described through reference to the Figures.

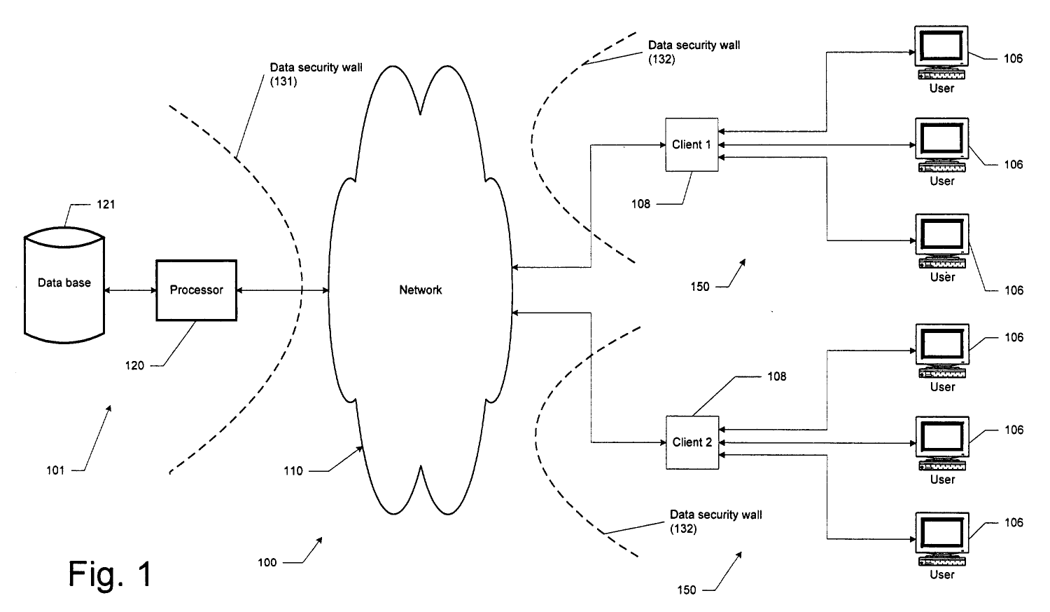

FIG. 1 is a schematic block diagram of a system suitable for implementing methods for blind trading of financial interests according to the invention. System 100 comprises trading server system 101 and a plurality of user or trader systems 150. Trading server system 101 and trader systems 150 are communicatively connected by communications link 110.

Trading server system 101 comprises one or more computers having one or more processors 120 and memory(ies) or database(s) 121. Processor(s) 120 comprises or is associated with input/output devices as required. Among other functions, processor 120 implements and/or controls input/output functions necessary or useful in communicating or otherwise interacting with trader systems 150 and in interacting with communications link 110; controls storage and manipulation of trading data, including terms for proposed transactions, in memory 121; and implements and/or controls trading functions as detailed in the methods described herein, including receipt from user/trader systems 150 of terms for proposed transactions and subsequent processing, identifying and matching of compatible counterproposals, and optionally execution of matched transactions; and includes hardware, firmware, and/or software necessary or desirable in accomplishing those tasks. Memory 121 comprises any data storage facilities or structures necessary or desirable in storing and/or holding data used in trading processes of the type described herein; and includes all hardware, firmware, and/or software necessary or desirable in accomplishing those tasks.

Trading server system 101 may also host/support other trading and/or non-trading functions. For example, trading server system 101 can support, in addition to the methods and systems disclosed herein, functions such as those available through the BLOOMBERG PROFESSIONAL® service, including the BLOOMBERG TRADEBOOK®, BLOOMBERG BOND TRADER®, SPEXTM, and/or BLOOMBERG POWERMATCH® trading systems.

Trader or other user systems 150 comprise software, firmware, and/or hardware elements required for enabling traders or other system users to communicate or otherwise interact with trading server system 101, including input/output systems and optional local servers 108 as appropriate, and to provide to trading server system 101 terms for proposed transactions, as described herein, and preferably receive information such as confirmation of proposals received by trading server system 101 and of matched and/or executed trades. Trader systems 150 can comprise, for example, one or desktop computer or terminal systems 106, including monitors, keyboards, pointing devices, and other input/output systems and the like. Optionally at least some of trader systems 150 are remotely located from trading server system 101, and are linked thereto by means of a computer or other communications network. For example, it is envisioned that many such terminals will be located in the offices of professional financial trading firms. Trader systems 150 may comprise pluralities of sub-trader systems such as local area networks and the like, as for example when operated by firms employing a number of traders, at least some of them having their own terminals or workstations.

Communications link 110 comprises any systems or components necessary or useful in communicatively linking trading server system 101 and trader systems 150. Such systems may comprise direct, indirect, wired, or wireless devices, in any combination(s) suitable for linking trading server system 101 and trader systems 150. Individual trader systems 150, or groups of them, may be linked in different ways. For example, in a system according to the invention some user systems 150 may be connected by means of a publicly-accessible network, accessed for example through the use of user i.d. and password, while other user systems 150 are connected by wireless links or via private communications network. Any communications link adaptable for service with trading server system 101 and whatever user systems 150 are employed will serve. For example, communications link may comprise the Internet, other wide-area or local-area networks, satellite or other wireless systems.

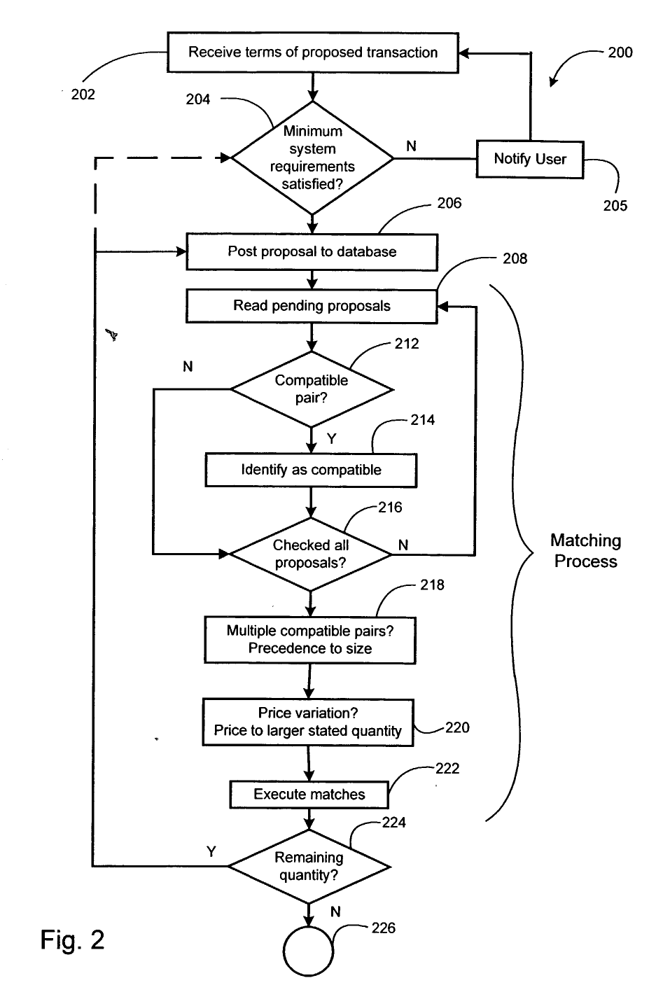

FIG. 2 is a schematic flow diagram of a method for trading of financial interests according to the invention, suitable for implementation on a system such as that shown in FIG. 1. Process 200 begins at 202 with a receiving by a trading server system of terms for a proposed transaction in financial interests, the terms being provided by a trader or other user of a user system 150. Terms may comprise, for example, a quantity of the interests to be traded, a price or pricing scheme, and optionally a period during which the proposal is valid, or an expiration time. Generally the party entering the proposal will also be required to identify itself, either directly as a part of the proposal statement, or implicitly by logging in with the trading system prior to entering the proposal terms, so that any resulting transaction(s) may be properly accounted for. Preferably transaction proposals are binding upon receipt.

At 204 the terms of the proposed trade are checked for compliance with any system requirements—for example, any minimum quantity, or any pricing requirements such as relation to the NBBO. If system requirements are not met the proposal is considered not qualified, and at 205 the system issues a suitable notification to the user entering the proposal and returns to block 202 to receive additional or corrected terms.

When an acceptable set of terms has been entered, at 206 the trading server writes the proposed transaction to a database 106 or other memory for pending proposals, so that it may kept and compared with other proposed transactions to determine whether any compatible proposals have been entered, so that matches may be made and a trade (or set of trades) completed. Preferably proposed transactions are not disclosed to parties other than the party by which they were entered.

At 208 the system begins a process of reviewing proposals posted to the proposal database 106. The review process begins at a time designated by the trader who entered the proposal, or upon initiation by the system itself. For example, the proposing party may designate a time for the proposal to become effective, or a deadline for entry of counterproposals; or the system may periodically or continually check the database for matching proposals, or may set a suitable time by default. The matching process begins at 208 with a reading by the system server of posted transaction proposals. Server 102 may read all proposals, or sets of proposals, at one time, and check them against each other for possible matches; or it may proceed on a trade-by-trade or other suitable basis.

At 212 server 102 reviews the read proposals and compares them to each other, to determine whether any compatible proposal pairs may be identified. Compatible proposals are identified, for example, on the basis of commonality of the interest to be traded and stated quantity, and compatibility of price, if maximum/minimum prices or spreads are stated. At 214 compatible pairs are identified, as for example by being written to a separate memory or data storage location, or by the association of suitable tags within the database.

At 216 a check is made to determine whether all compatible proposals have been identified. If not, the process returns to 208. The process of identifying compatible proposals continues from 208 through 216 until a determination is made that all possible or appropriate matches have been identified. Any one proposed transaction may be matched with any number of counterproposals.

At 218 server 104 begins to review identified compatible proposals to determine, for each set of compatible proposals, a matching pair. If only one proposal and one compatible counterproposal have been identified, the pair is matched and the parties notified, and preferably the trade is executed. If more than one compatible pair has been identified, the system determines which pair to match. According to a preferred method of identifying a best matching pair, the size of the transaction that would result from a given matching is given precedence over either the resulting price to be paid/collected as a result of the transaction or the time order in which proposals were made, or any other factors, so long as minimum price and other expectations of the respective parties are satisfied (that is, so long as the pair is compatible). For example, if two proposals for the purchase of an interest are compatible with an order to sell that interest, and the two purchase proposals state different (yet both sufficient) price terms, the proposal which will result in the larger trade will be matched with the sell proposal, regardless of price.

Quantity can also be given precedence over other terms, such as the order in which counterproposals have been received. For example, if two sell proposals are matched with a buy proposal, at identical prices, but one proposes selling a larger quantity, the proposal for selling the larger quantity can be matched with the buy proposal, even if it the larger sell proposal was received after the smaller.

A preference for quantity can also be made by giving precedence to proposals stating a desire to trade larger quantities, even if in fact they may only be matched with counterproposals which will result in trades no larger than those proposed by other traders. For example, if two proposals stating similar price terms but different quantities are compatible with a counterproposal having a quantity term identical to the smaller proposal, a match can be made involving the larger proposal.

As will occur immediately to those familiar with methods and systems for trading of financial interests, a great variety of other matching rules, particularly methods which give precedence to trading quantity over price or time of entry, are suitable for use with the invention.

In cases where quantity is given precedence over price, the system determines for each compatible proposal set which transaction or combination of transactions will result in the transfer of the greatest quantity of the financial interest at stake, and, where choices between potential matches are available, as a secondary matter determines which transaction or combination will result in the best price for the proposing traders, whether the best price is the highest, for a proposing seller, or lowest, for a proposing purchaser.

One method for reviewing possible compatible proposals is to review each potential match, one at a time, and determine which provides the most satisfactory match, on a factor-by-factor basis. Thus at 218 to 220 server 104 reviews all identified possible matches. When a best match, or set of matches, has been identified, at 222 a suitable record is created, the parties entering the proposals are notified, and optionally the trade is executed. Optionally one or both parties are provided an opportunity to accept or reject the match and any proposed trade prior to execution or other commitment.

At 224 server 104 determines whether the trade or trades executed at 222 have fully satisfied the proposed transaction. That is, a determination is made as to whether all of the proposed quantities have been traded. If any quantity of a proposed transaction remains, and satisfies any system requirements for continuing or re-posting, as for example is sufficiently large to satisfy any requirements as to minimum fill or minimum order size, and/or any continuing price requirements, at 206 (or 204, if appropriate) the remaining portions of the proposed transaction are re-posted.

If all proposed transactions have been satisfied in their entireties, at 226 the function stops, or passes to a new cycle, or to a new function, as determined by the system operator and/or the system user.

Optionally checking of a proposed transaction for satisfaction of minimum requirements, as at block 204, is repeated for every cycle through blocks 208 to 224.

Application of one process for matching trades by giving precedence to size over price is illustrated in the following examples:

### EXAMPLE 1

Blind bid proposals for trading of common corporate equity stocks, entered by Participant A and Participant B in a blind trading system according to the invention, are both identified as compatible with a publicly-disclosed offer for the same stock entered into an associated open-display system by Participant C.

The current NBB is 0.25, the NBO 0.50.

Participant A has entered a bid for 50,000 shares at a price of 0.75, with a minimum fill of 25,000 shares. A's bid is above both NBB and NBO.

Participant B has entered a bid for 25,000 shares AON (all or nothing), also at a price of 0.75.

Participant C enters a disclosed offer of 25,000 shares at 0.625.

Although a trade with either A or B will result in a sale of an identical quantity at an identical price, A and C are matched and trade, because A sought to purchase a larger quantity than B.

### EXAMPLE 2

A blind bid for common corporate equity stocks is entered by Participant A, a blind offer for the same stocks, by Participant B, both in a blind trading system according to the invention.

The current NBB is 3/8, the NBO ⅝.

Participant A has entered a bid for 50,000 shares a price of 3/4, with a minimum fill of 25,000 shares.

Participant B has entered an offer for 1/4 for 25,000 shares AON.

A and B are matched and trade 25,000 shares at 1/4. Price improvement is attributed to the larger order in order to give precedence to size over price.

It will be understood that the systems and programming referenced herein include, either explicitly or implicitly, software implemented on computers or other appropriate hardware, including such other intelligent data processing devices having a processor, data storage means, and the ability to support an operating system, with or without user interfaces, for example, file servers, as may be useful in achieving the objectives of this invention.

Software components and applications embodying the invention can be distributed in electronic bit storage embodied on magnetic, optical, bubble, or other media, and optionally in transportable form to be interactive with an electronic reading device, for example, on computer or optical diskettes, or may be distributed over wired or wireless networks for storage by the recipient on such media.

It will further be appreciated that such media-stored software constitutes an electronic customizing machine which can interact with a magnetically or optically cooperative computer-based input device enabling the computer to be customized as a special purpose computer, according to the contents of the software. To cause a computer to operate in such a customized, special-purpose mode, the software of the invention can be installed by a user or some other person, and will usually interact efficiently with the device on which it resides to provide the desired special-purpose functions or qualities, but only after the selection of a certain set of configuration parameters. When so configured, the special-purpose computer device has an enhanced value, especially to the professional users for whom it may be intended.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

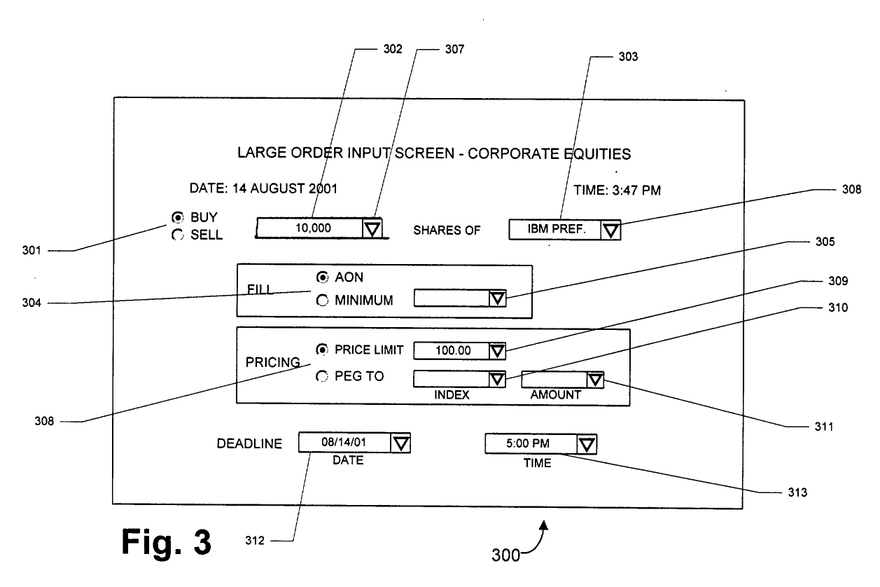

FIG. 3 is a schematic diagram of an example of a computer interface screen 300 useful for entry of terms for proposed transactions by parties desiring to trade financial interests using a system according to the invention, using a trader station such as one of client systems 150, 106.

An order or proposal entry screen such as screen 300 is displayed at a trading party terminal 106 upon request by a trading party. Typically a trading party accesses a trading system via a computer network, as for example by accessing an Internet website or logging in at a terminal on a private communications network. After identifying him- or herself and receiving authorization for access to the system, the trader is presented with a user interface screen from which he or she is enabled to designate or otherwise enter various trading commands. For example, screen 300 is presented to a trader who has successfully accessed the trading system and specified that he/she wishes to buy corporate equity securities (i.e., stocks).

Screen 300 is adapted to elicit and facilitate collection of all terms needed to define a transaction proposal, and optionally any other desired data. Data is entered through the use of any suitable input/output device(s), such as for example a keyboard, mouse, trackball, or other pointing device, or any other suitable interface controller(s), by selecting appropriate screen icons and/or entering data in response to prompts such as provided data input fields. Data input by the user/trader is read by or sent to server system 101, and processed accordingly.

In the instance shown in FIG. 3, the trader proposing the transaction is allowed to designate whether he/she is entering a buy or a sell order by making the suitable selection at 301, as for example by positioning a cursor using a pointing device such as a mouse, and activating a control button. At 302 the trader is enabled to designate a quantity term for the proposal, for example by positioning a cursor and typing in an amount via a keyboard. Alternatively, a default range or set of quantity levels may be provided via a Windows pull-down menu by selecting icon 307, and making an appropriate selection on a list that appears as a result. At 303 the trader is enabled to designate the identity of the financial interest to be traded. Again, an entry such as a stock ticker symbol, with or without additional annotations, may be made by means of a keyboard, a pull-down menu 306, or in other suitable manner.

At 304 the user is offered any order fill options the supported by the system. For example, a trader is offered the option of requiring “all or nothing” (AOL) trading, or of stating a minimum fill size. Optionally an order refill increment may be set also, so that upon execution of an order for at least minimum fill subsequent orders from reserve may be of a size determined by the trader entering the proposal. Again, default minimum fill sizes may be offered through use of a pull-down menu or other device.

At 308 the trader is enabled to select from among supported pricing options. For example, the trader is offered the option of stating an upper (for purchase) or lower (for sale) limit on price, usually set in amount per unit interest (e.g., dollars/share), and/or to peg the price to an index such as the price of another stock. At 310, for example, the user may enter an identifier for a pegging index, and at 311 an offset amount, as for example a an absolute currency step (for example, 10$/share above the price of a designated index stock) or a percentage (for example, float 10% above the price of a designated index interest).

At 312 and 313 the trader is enabled to specify a deadline for acceptance of the proposal, after which, if set, the proposal is considered withdrawn.

What is claimed is:

1. A system for matching of orders in financial interests over a network, comprising at least one computer programmed to:
accept orders including price and quantity terms in one or more financial interests provided to the at least one computer by potential trading parties over the computer network for possible matching;
provide a level of access to information relating at least to the price and quantity terms of selected orders accepted by the at least one computer for possible matching that is more restrictive than a level of access to information related to orders accepted by the system other than the selected orders; and
match accepted orders while maintaining the level of access at least for selected orders that are unmatched.

2. The system of claim 1, wherein the at least one computer is programmed to provide a level of access to information relating at least to the price and quantity terms of a selected order or orders of a party that precludes access to such information at least by other parties.

3. The system of claim 1, wherein the at least one computer is programmed to match accepted selected orders with a priority for quantity where there is not a match of both the price and quantity terms of a pair of such orders.

4. A system for matching of orders in financial interests over a network, comprising at least one computer programmed to:
receive terms for proposed transactions in financial interests;
review received terms to identify proposed transactions having compatible terms; and
when at least two compatible counterproposals to a single proposed transaction have been identified, match the proposed transaction with the counterproposal which would result in trading of the greatest quantity of financial interests.

5. The system of claim 4, wherein the terms comprise quantities of financial interests to be traded, and the proposals are required to meet at least one of a minimum size restriction and a minimum aggregate value.

6. The system of claim 4, wherein at least some received terms are not disclosed to trading parties other than those from whom the terms are received.

7. The system of claim 4, wherein the compatible terms comprise compatible price limits.

8. The system of claim 4, wherein the compatible terms comprise compatible minimum fill quantities.

9. The system of claim 4, wherein programming that causes the system to match proposed transactions causes the system to tentatively match transactions, and the system comprises programming for causing the system to receive approval of tentatively matched transactions from at least one party from whom terms for a tentatively-matched transaction have been received.

10. A system for matching of orders in financial interests over a network, comprising at least one computer programmed to:
receive terms for proposed transactions in financial interests, the terms comprising quantities of financial interests to be traded and qualifying prices for counterproposals;
review the received terms to identify proposed transactions having compatible terms without disclosing the terms or the proposed-transactions to trading parties other than those from whom the terms are received, the compatible terms comprising compatible qualifying prices; and
match proposed transactions, giving precedence to quantity over price.

11. The system of claim 10, wherein the proposals are required to meet at least one of a minimum size restriction and a minimum aggregate value.

12. The system of claim 10, wherein qualifying prices may be set relative to at least one index.

13. The system of claim 12, wherein the at least one index comprises at least one of national best bid (NBB) and national best offer (NBO).

14. The system of claim 12, wherein the system will identify a first proposed transaction as comprising terms compatible with a second proposed transaction only if the index satisfies a specified condition.

15. A system for matching of orders in financial interests over a network, comprising at least one computer programmed to:
receive terms for proposed transactions in financial interests, the terms comprising quantities of financial interests to be traded;
review the received terms to identify proposed transactions having compatible terms; and
match proposed transactions;
wherein in matching proposed transactions the system gives precedence to quantity over an order in which the transactions were proposed.

16. The system of claim 15, wherein the at least one computer is programmed to review received terms and match proposed transactions without disclosing the terms or the proposed transactions to trading parties other than those from whom the terms are received.

17. The system of claim 15, wherein compatible terms comprise compatible qualifying prices.

18. A system for matching of orders in financial interests over a network, the system comprising at least one computer programmed to:
receive terms for proposed transactions in financial interests, the terms including quantities of financial interests desired to be traded and minimum fill specifications;
review received terms to identify proposed transactions having compatible terms, the compatible terms comprising at least one minimum fill specification; and
when a proposal and a counterproposal have been identified, match the proposal and the counterproposal at a price favoring the party proposing the transaction with the larger quantity term.

19. The system of claim 18, wherein the at least one computer is programmed to review received terms and match proposed transactions without disclosing the terms or the proposed transactions to trading parties other than those from whom the terms are received.

20. A system for matching of orders in financial interests over a network, comprising at least one computer programmed to:
receive terms for proposed transactions in financial interests;
review received terms to identify proposed transactions having compatible terms without disclosing the terms or the proposed transactions to trading parties other than those from whom the terms are received; and
match compatible counterproposals.

21. A computer usable medium having computer readable code embodied therein for causing a computer to:
accept orders including price and quantity terms in one or more financial interests provided to the at least one computer by potential trading parties over the computer network for possible matching;
provide a level of access to information relating at least to the price and quantity terms of selected orders accepted by the at least one computer for possible matching that is more restrictive than a level of access to information related to orders accepted by the system other than the selected orders; and
match accepted orders while maintaining the level of access at least for selected orders that are unmatched.

22. The medium of claim 21, comprising computer readable code for causing a computer to provide a level of access to information relating at least to the price and quantity terms of a selected order or orders of a party that precludes access to such information at least by other parties.

23. The medium of claim 21, comprising computer readable code for causing a computer to match accepted selected orders with a priority for quantity where there is not a match of both the price and quantity terms of a pair of such orders.

24. A computer usable medium having computer readable code embodied therein for causing a computer to:
receive terms for proposed transactions in financial interests;
review received terms to identify proposed transactions having compatible terms; and
when at least two compatible counterproposals to a single proposed transaction have been identified, match the proposed transaction with the counterproposal which would result in trading of the greatest quantity of financial interests.

25. The medium of claim 24, wherein the terms comprise quantities of financial interests to be traded, and the proposals are required to meet at least one of a minimum size restriction and a minimum aggregate value.

26. The medium of claim 24, wherein at least some received terms are not disclosed to trading parties other than those from whom the terms are received.

27. The medium of claim 24, wherein the compatible terms comprise compatible price limits.

28. The medium of claim 24, wherein the compatible terms comprise compatible minimum fill quantities.

29. The medium of claim 24, having computer readable code for causing a computer to match proposed transactions causes the system to tentatively match transactions, and the system comprises programming for causing the system to receive approval of tentatively matched transactions from at least one party from whom terms for a tentatively-matched transaction have been received.

30. A computer usable medium having computer readable code embodied therein for causing a computer to:
receive terms for proposed transactions in financial interests, the terms comprising quantities of financial interests to be traded and qualifying prices for counterproposals;
review the received terms to identify proposed transactions having compatible terms without disclosing the terms or the proposed transactions to trading parties other than those from whom the terms are received, the compatible terms comprising compatible qualifying prices; and
match proposed transactions, giving precedence to quantity over price.

31. The medium claim 30, wherein the proposals are required to meet at least one of a minimum size restriction and a minimum aggregate value.

32. The medium of claim 30, wherein qualifying prices may be set relative to at least one index.

33. The medium of claim 32, wherein the at least one index comprises at least one of national best bid (NBB) and national best offer (NBO).

34. The medium of claim 32, wherein the system will identify a first proposed transaction as comprising terms compatible with a second proposed transaction only if the index satisfies a specified condition.

35. A computer usable medium having computer readable code embodied therein for causing a computer to:
receive terms for proposed transactions in financial interests, the terms comprising quantities of financial interests to be traded;
review the received terms to identify proposed transactions having compatible terms; and
match proposed transactions;
wherein in matching proposed transactions the system gives precedence to quantity over an order in which the transactions were proposed.

36. The medium of claim 35, wherein the at least one computer is programmed to review received terms and match proposed transactions without disclosing the terms or the proposed transactions to trading parties other than those from whom the terms are received.

37. The medium of claim 35, wherein compatible terms comprise compatible qualifying prices.

38. A computer usable medium having computer readable code embodied therein for causing a computer to:
receive terms for proposed transactions in financial interests, the terms including quantities of financial interests desired to be traded and minimum fill specifications;
review received terms to identify proposed transactions having compatible terms, the compatible terms comprising at least one minimum fill specification; and
when a proposal and a counterproposal have been identified, match the proposal and the counterproposal at a price favoring the party proposing the transaction with the larger quantity term.

39. The medium of claim 38, wherein the at least one computer is programmed to review received terms and match proposed transactions without disclosing the terms or the proposed transactions to trading parties other than those from whom the terms are received.

40. A computer usable medium having computer readable code embodied therein for causing a computer to:
receive terms for proposed transactions in financial interests;
review received terms to identify proposed transactions having compatible terms without disclosing the terms or the proposed transactions to trading parties other than those from whom the terms are received; and match compatible counterproposals.

41. A method for matching of orders in financial interests over a network, comprising:
accepting orders including price and quantity terms in one or more financial interests provided to the at least one computer by potential trading parties over the computer network for possible matching;
providing a level of access to information relating at least to the price and quantity terms of selected orders accepted by the at least one computer for possible
matching that is more restrictive than a level of access to information related to orders accepted by the system other than the selected orders; and
matching accepted orders while maintaining the level of access at least for selected orders that are unmatched.

42. The method of claim 41, comprising providing a level of access to information relating at least to the price and quantity terms of a selected order or orders of a party that precludes access to such information at least by other parties.

43. The method of claim 41, comprising matching accepted selected orders with a priority for quantity where there is not a match of both the price and quantity terms of a pair of such orders.

44. A method for matching of orders in financial interests over a network, comprising:
receiving terms for proposed transactions in financial interests;
reviewing received terms to identify proposed transactions having compatible terms; and
when at least two compatible counterproposals to a single proposed transaction have been identified, matching the proposed transaction with the counterproposal which would result in trading of the greatest quantity of financial interests.

45. The method of claim 44, wherein the terms comprise quantities of financial interests to be traded, and the proposals are required to meet at least one of a minimum size restriction and a minimum aggregate value.

46. The method of claim 44, wherein at least some received terms are not disclosed to trading parties other than those from whom the terms are received.

47. The method of claim 44, wherein the compatible terms comprise compatible price limits.

48. The method of claim 44, wherein the compatible terms comprise compatible minimum fill quantities.

49. The method of claim 44, wherein programming that causes the system to match proposed transactions causes the system to tentatively match transactions, and the system comprises programming for causing the system to receive approval of tentatively matched transactions from at least one party from whom terms for a tentatively-matched transaction have been received.

50. A method for matching of orders in financial interests over a network, comprising:
receiving terms for proposed transactions in financial interests, the terms comprising quantities of financial interests to be traded and qualifying prices for counterproposals;
reviewing the received terms to identify proposed transactions having compatible terms without disclosing the terms or the proposed transactions to trading parties other than those from whom the terms are received, the compatible terms comprising compatible qualifying prices; and
matching proposed transactions, giving precedence to quantity over price.

51. The method of claim 50, wherein the proposals are required to meet at least one of a minimum size restriction and a minimum aggregate value.

52. The method of claim 50, wherein qualifying prices may be set relative to at least one index.

53. The method of claim 52, wherein the at least one index comprises at least one of national best bid (NBB) and national best offer (NBO).

54. The method of claim 52, comprising identifying a first proposed transaction as comprising terms compatible with a second proposed transaction only if the index satisfies a specified condition.

55. A method for matching of orders in financial interests over-a network, comprising:
receiving terms for proposed transactions in financial interests, the terms comprising quantities of financial interests to be traded;
reviewing the received terms to identify proposed transactions having compatible terms; and
matching proposed transactions, giving precedence to quantity over an order in which the transactions were proposed.

56. The method of claim 55, comprising reviewing received terms and matching proposed transactions without disclosing the terms or the proposed transactions to trading parties other than those from whom the terms are received.

57. The method of claim 55, wherein compatible terms comprise compatible qualifying prices.

58. A method for matching of orders in financial interests, comprising:
receiving terms for proposed transactions in financial interests, the terms including quantities of financial interests desired to be traded and minimum fill specifications;
reviewing received terms and identifying proposed transactions having compatible terms, the compatible terms comprising at least one minimum fill specification; and
when a proposal and a counterproposal have been identified, matching the proposal and the counterproposal at a price favoring the party proposing the transaction with the larger quantity term.

59. The method of claim 58, comprising reviewing received terms and matching proposed transactions without disclosing the terms or the proposed transactions to trading parties other than those from whom the terms are received.

60. A method for matching of orders in financial interests:
receiving terms for proposed transactions in financial interests;
reviewing received terms to identify proposed transactions having compatible terms without disclosing the terms or the proposed transactions to trading parties other than those from whom the terms are received; and
matching compatible counterproposals.
